(19) United States
(12) Patent Application Publication
(10) Pub. No.: US 2026/0103007 A1
(43) Pub. Date: Apr. 16, 2026

(54) INKJET RECORDING SYSTEM

(71) Applicant: Konica Minolta, Inc., Tokyo (JP)

(72) Inventors: Eiji TABATA, Tokyo (JP); Hiroshi SHIBATA, Tokyo (JP); Mai NAGANO, Tokyo (JP)

(21) Appl. No.: 19/347,797

(22) Filed: Oct. 2, 2025

(30) Foreign Application Priority Data
Oct. 16, 2024 (JP) 2024-180537

(51) Int. Cl. B41J 2/175; B41J 2/045; B41J 2/17; B41J 2/19; B41J 2/21

(52) U.S. Cl. CPC B41J 2/17596; B41J 2/0451; B41J 2/04586; B41J 2/1707; B41J 2/19; B41J 2/2107; B41J 2202/07

(57) ABSTRACT

An inkjet recording system that forms an image by ejecting ink from an inkjet head is shown, and the inkjet recording system includes, a deaeration module including a gas permeable membrane that can deaerate a dissolved gas in the ink having external contact; and a liquid storage that communicates with the gas permeable membrane and that stores a liquid component of the ink having permeated the gas permeable membrane; a discharge channel that communicates with the liquid storage and through which the liquid component accumulated in the liquid storage is discharged; and a pressure adjuster that causes the liquid component to be discharged to the discharge channel by providing a pressure difference between the liquid storage and the discharge channel.

### CROSS-REFERENCE TO RELATED APPLICATION

The entire disclosure of Japanese Patent Application No. 2024-180537, filed on Oct. 16, 2024, including description, claims, drawings and abstract is incorporated herein by reference.

### BACKGROUND OF THE INVENTION

### Technical Field

The present invention relates to an inkjet recording system.

### Description of Related Art

Conventionally, inkjet recording apparatuses are known that record an image by ejecting an ink droplet from an inkjet head onto a recording surface of a recording medium. In the inkjet recording apparatus, when a gas is dissolved in the ink, the gas causes a problem. Therefore, on an ink supply path to the inkjet head, a deaeration module is provided which deaerates the ink through a gas permeable membrane. The deaeration module is brought into an airtight state, and the ink is brought into contact with the gas permeable membrane which is decompressed by sucking the internal air by a suction section, so that the dissolved gas in the ink permeates the gas permeable membrane.

On the other hand, in such a deaeration module, not only the dissolved gas but also a liquid component of the ink may permeate through the gas permeable membrane. When the liquid component that has permeated through the gas permeable membrane reaches the suction section, a malfunction or the like occurs. Therefore, a configuration is known in which a storage section that stores the liquid component is provided in the middle of a suction path that communicates the deaeration module with the suction section.

However, when the storage section becomes full of the liquid component and overflows, a malfunction or the like similarly occurs. Therefore, it is necessary to prevent the liquid component from overflowing by discharging the liquid component before the storage section becomes full of the liquid component. For example, Japanese Unexamined Patent Publication No. 2021-017029 describes a configuration in which a storage amount of the liquid component in the storage section is estimated, and when the storage amount reaches a predetermined value, cleaning is performed to discharge the liquid component.

However, in the invention of Japanese Unexamined Patent Publication No. 2021-017029, a service person manually cleans the storage section to remove the liquid component. In particular, in the invention of Japanese Unexamined Patent Publication No. 2021-017029, UV ink that is cured by being irradiated with ultraviolet rays is used, and the liquid component is highly viscous, and there is a risk that the ink is cured by leaked light. Therefore, it takes time and effort to manually remove the liquid component, which leads to an increase in cost and a decrease in productivity.

### SUMMARY OF THE INVENTION

The present invention has been made in view of such circumstances. The object is to provide an inkjet recording system capable of removing a liquid component in a storage section without troubling a user.

In order to solve the above problems, according to one aspect of the present invention, an inkjet recording system that forms an image by ejecting ink from an inkjet head, the inkjet recording system includes:
a deaeration module including a gas permeable membrane that can deaerate a dissolved gas in the ink having external contact; and
a liquid storage that communicates with the gas permeable membrane and that stores a liquid component of the ink having permeated the gas permeable membrane;
a discharge channel that communicates with the liquid storage and through which the liquid component accumulated in the liquid storage is discharged; and
a pressure adjuster that causes the liquid component to be discharged to the discharge channel by providing a pressure difference between the liquid storage and the discharge channel.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a cross-sectional side view of an inkjet recording apparatus;

FIG. 2 is a schematic configuration diagram of a liquid delivery section in an inkjet recording system according to a first embodiment;

FIG. 3 is a cross-sectional side view of a deaeration module;

FIG. 4 is a block diagram of the inkjet recording apparatus;

FIG. 5 is a flowchart of liquid component discharge processing in the inkjet recording system according to the first embodiment;

FIG. 6 is a graph illustrating a change in a pressure value of a normal discharge channel in liquid component discharge processing of the inkjet recording system according to the first embodiment;

FIG. 7 is a graph illustrating a change in a pressure value of the discharge channel having clogging in the liquid component discharge processing of the inkjet recording system according to the first embodiment, together with the change in the pressure value of the normal discharge channel;

FIG. 8 is a graph illustrating the change in the pressure value of the discharge channel having a leakage in the liquid component discharge processing of the inkjet recording system according to the first embodiment, together with the change in the pressure value of the normal discharge channel;

FIG. 9 is a diagram illustrating an example of display content of a notification section;

FIG. 10 is a schematic configuration diagram of the liquid delivery section in the inkjet recording system according to a second embodiment;

FIG. 11 is a schematic configuration diagram of the liquid delivery section in the inkjet recording system according to a third embodiment;

FIG. 12 is a schematic configuration diagram of the liquid delivery section in the inkjet recording system according to a fourth embodiment;

FIG. 13 is a flowchart of liquid component discharge processing in the inkjet recording system according to the fourth embodiment;

FIG. 14 is a graph illustrating the change in the pressure value of the discharge channel in a case where a cleaning jig has a connection failure, together with the change in the pressure value of the normal discharge channel, in the liquid component discharge processing of the inkjet recording system according to the fourth embodiment; and

FIG. 15 is a flowchart of leakage spot identification processing in the inkjet recording system according to the fourth embodiment.

### DETAILED DESCRIPTION

Hereinafter, one or more embodiments of the present disclosure will be described with reference to the drawings. However, the scope of the invention is not limited to the disclosed embodiments.

Hereinafter, an inkjet recording system according to an embodiment of the present invention is described in detail with reference to the drawings. However, the scope of the invention is not limited to the illustrated examples. In the following description, components having the same functions and configurations are denoted by the same reference numerals, and the description thereof will be omitted.

### First Embodiment

### Overall Configuration of Inkjet Recording System

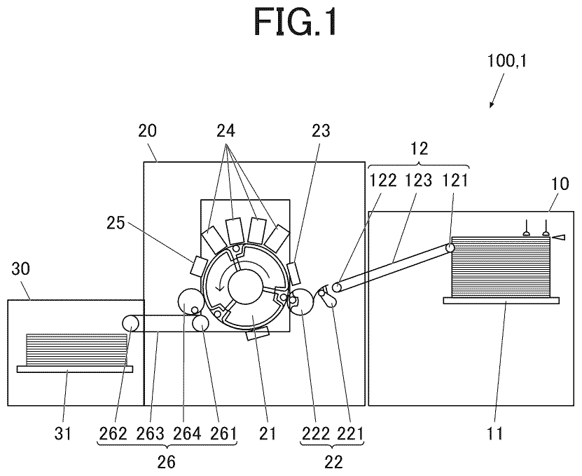

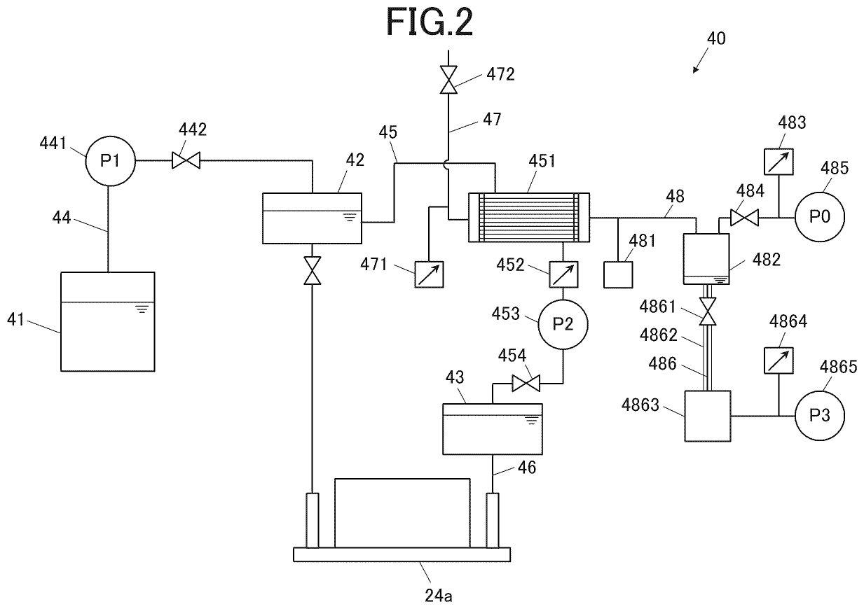

FIG. 1 is a side sectional view showing a main configuration of an inkjet recording system 100 according to a first embodiment. The inkjet recording system 100 includes an inkjet recording apparatus 1 including, for example, a sheet feed section 10, an image forming section 20, a sheet ejection section 30, a liquid delivery section 40 (see FIG. 2), a controller 50 (hardware processor), a notification section (notifier) 60, and an operation input section 70 (see FIG. 4 for all).

The inkjet recording apparatus 1 conveys a recording medium from the sheet feed section 10 to the image forming section 20 based on control of the controller 50. Then, the controller 50 causes the image forming section 20 to form an image on the recording medium with the ink supplied from the liquid delivery section 40. After the image formation, the controller 50 ejects the recording medium to the sheet ejection section 30.

### (Sheet Feed Section)

The sheet feed section 10 stores a recording medium before image formation. The sheet feed section 10 conveys a recording medium to the image forming section 20 under the control of the controller 50. The sheet feed section 10 includes a sheet feed tray 11 and a conveyance section 12.

### {Sheet Feed Tray}

The sheet feed tray 11 is a plate member that stores the recording medium. The sheet feed tray 11 is provided so that one or a plurality of recording medium can be placed thereon. The sheet feed tray 11 moves up and down in accordance with an amount of the recording medium placed thereon. By such vertical movement, the sheet feed tray 11 is held at a position where the uppermost recording medium is conveyed by the conveyance section 12.

### {Conveyance Section}

The conveyance section 12 conveys the recording medium from the sheet feed tray 11 to the image forming section 20. The conveyance section 12 includes a conveyance mechanism. The conveyance mechanism drives a belt 123 to convey the recording medium on the belt 123. The belt 123 has a ring shape, and the inner side of the ring is supported by a plurality of rollers 121 and 122. The conveyance section 12 delivers the uppermost recording medium placed on the sheet feed tray 11 onto the belt 123, and conveys the recording medium along the belt 123.

### (Image Forming Section)

The image forming section 20 forms the image on the recording medium in cooperation with the liquid delivery section 40 under the control of the controller 50. The image forming section 20 includes an image forming drum 21, a handover unit 22, a sheet heating section 23, a head unit 24, an irradiation section 25, and a delivery section 26.

### {Image Forming Drum}

The image forming drum 21 conveys the recording medium along a cylindrical outer periphery surface, and conveys the recording medium with rotation. A conveyance surface of the image forming drum 21 faces the sheet heating section 23, the head unit 24, and the irradiation section 25, and performs an image formation processing on the recording medium that is conveyed.

### {Handover Unit}

The handover unit 22 is provided in a position between the conveyance section 12 and the image forming drum 21. The handover unit 22 includes a claw 221 and a handover drum 222.

The claw 221 is a cylindrical member that holds one end of the recording medium conveyed by the conveyance section 12. The handover drum 222 is a member that guides the recording medium borne by the claw 221.

The handover unit 22 picks up the recording medium on the conveyance section 12 with the claw 221, and places the recording medium along an outer periphery surface of the handover drum 222. The handover unit 22 hands over the recording medium to the image forming drum 21 by the operation.

### {Sheet Heating Section}

The sheet heating section 23 includes, for example, a heating wire and generates heat in response to energization. The sheet heating section 23 is controlled by the controller 50 to generate the heat so that the recording medium passing through the vicinity thereof reaches a predetermined temperature. The sheet heating section 23 is provided so as to be located in the vicinity of the outer periphery surface of the image forming drum 21 and on the upstream of the head unit 24 in a conveyance direction of the recording medium.

A temperature sensor (not illustrated) is provided near the sheet heating section 23. With the temperature sensor, the controller 50 senses a temperature around the sheet heating section 23. Based on the sensed temperature, the controller 50 controls heat generation of the sheet heating section 23.

### {Head Unit}

The head unit 24 includes, for example, a plurality of inkjet heads 24a (refer to FIG. 2). The head unit 24 forms the image by ejecting ink droplets onto the recording medium from a nozzle. The head unit 24 corresponding to the colors of C (cyan), M (magenta), Y (yellow), and K (black) are provided for each color. In FIG. 1, the head unit 24 corresponding to the respective colors of Y, M, C, and K are provided in this order from the upstream with respect to the conveyance direction of the recording medium.

Here, a direction perpendicular to the conveyance direction of the recording medium in a plan view is defined as a width direction. A plurality of the head units 24 are provided to be arranged in the width direction so as to have a length (width) that covers the entirety of the recording medium. That is, the inkjet recording apparatus 1 is a line head type inkjet recording apparatus of a one pass system (single pass system). The head unit 24 is configured by arranging a plurality of inkjet heads 24a which are droplet ejection heads.

The number of the head units 24 may be equal to or greater than 5 or equal to or less than 3. Further, a single inkjet head 24a may constitute the head unit 24. The inkjet recording apparatus 1 may be a serial head-type inkjet recording apparatus of a multi-pass system (scanning system) in which the head unit 24 whose length in the width direction is shorter than that of the recording medium reciprocates in the width direction.

The ink discharged by the head unit 24 is, for example, ultraviolet curable ink (UV ink). The ultraviolet curable ink contains, for example, an ultraviolet curable resin. The ultraviolet curable resin contains a monomer and a polymerization initiator. When the ink containing the ultraviolet curable resin is irradiated with ultraviolet rays, the monomer is polymerized and cured by the action of the polymerization initiator, and the ink is fixed to the recording medium.

The ink ejected by the head unit 24 may contain a gelling agent. The ink containing the gelling agent changes in phase between a gel state and a liquid (sol) state depending on the temperature. The ink containing the gelling agent has a phase change temperature of, for example, about 40 to 100° C., and is uniformly liquefied (solated) by being heated to a phase change temperature or higher. On the other hand, the ink containing the gelling agent is gelled at about normal room temperature, that is, about 0 to 30° C. Therefore, the ink in the head unit 24 is heated to an appropriate temperature by an ink heater or the like (not illustrated) to be brought into a sol state. Then, after the ink is ejected and the ink lands on the recording medium, the ink is moderately transferred to a gel state while the recording medium is conveyed by the image forming drum 21.

### {Irradiation Section}

The irradiation section 25 includes, for example, a fluorescent tube such as a low-pressure mercury lamp. The irradiation section 25 emits energy rays such as ultraviolet rays by light emission of the fluorescent tube. The irradiation section 25 is provided near the outer peripheral surface of the image forming drum 21. The irradiation section 25 is provided so as to be located on the downstream of the head unit 24 in the conveyance direction of the recording medium. The irradiation section 25 irradiates the recording medium on which the ink has been ejected with energy rays. In a case where the ink on the recording medium is UV ink, the ink is cured by the action of the energy rays.

The fluorescent tube that emits ultraviolet rays is not limited to the low-pressure mercury lamp. The fluorescent tube may be a mercury lamp having an operating pressure of a few hundred Pa to 1 MPa, for example. The fluorescent tube may be a light source usable as a bactericidal lamp, for example, a cold-cathode tube, an ultraviolet laser light source, a metal halide lamp, a light-emitting diode, or the like. The fluorescent tube is desirably a power saving light source capable of emitting ultraviolet rays with higher illuminance. The fluorescent tube is, for example, the light-emitting diode. The energy rays are not limited to the ultraviolet rays and may be the energy rays having a property of curing the ink depending on the property of the ink. The light source is substituted depending on the energy rays.

In the above description, the case where the head unit 24 discharges the ultraviolet curable ink or the ink containing the gelling agent is exemplified, but the invention is not limited thereto. The ink ejected by the head unit 24 may be water-based ink or ink having other physical properties.

### {Delivery Section}

The delivery section 26 includes a conveyance mechanism. The conveyance mechanism drives a ring-shaped belt 263 whose inner side is supported by a plurality of rollers 261 and 262 to convey the recording medium. The delivery section 26 includes a cylindrical handover roller 264. The handover roller 264 hands over the recording medium from the image forming drum 21 to the conveyance mechanism. The delivery section 26 conveys the recording medium delivered onto the belt 263 by the handover roller 264, and sends it to the sheet ejection section 30.

### (Sheet Ejection Section)

The recording medium on which the image is formed by the image forming section 20 is ejected to the sheet ejection section 30. The sheet ejection section 30 includes a plate-shaped sheet ejection tray 31. The recording medium sent from the image forming section 20 by the delivery section 26 is placed on the sheet ejection tray 31.

The sheet ejection section 30 stores the recording medium until the user takes out the recording medium.

### (Liquid Delivery Section)

FIG. 2 shows a schematic configuration diagram of the liquid delivery section 40. The liquid delivery section 40 includes a plurality of main tanks 41 that store the respective colors of ink. The liquid delivery section 40 supplies the ink of each color in the main tank 41 to the inkjet head 24a of each head unit 24. According to such control, the liquid delivery section 40 allows the ink of each color to be dischargeable from the nozzle.

As illustrated in FIG. 2, the liquid delivery section 40 includes a main tank 41, a first sub-tank 42, and a second sub-tank 43. The liquid delivery section 40 also includes a deaeration module 451 that removes gas dissolved in the ink before the ink is delivered to the head unit 24.

### <Main Tank>

The main tank 41 is a tank that stores ink to be supplied to each part of the liquid delivery section 40. The main tank 41 is, for example, a rigid sealed tank made of metal. The main tank 41 is connected to the first sub-tank 42 via a supply pipe 44.

### <First Sub-tank>

The first sub-tank 42 is one or a plurality of ink chambers having a smaller volume than the main tank 41. The ink pumped out of the main tank 41 by the supply pump 441 is stored in the first sub-tank 42. By providing the first sub-tank 42, pressure fluctuation due to pulsation when the supply pump 441 supplies the ink in the main tank 41 is alleviated. The ink that has not been discharged from the inkjet head 24a is collected to the first sub-tank 42 from the outlet. The first sub-tank 42 is connected to the second sub-tank 43 via a liquid delivery tube 45.

### <Second Sub-Tank>

The second sub-tank 43 is a small tank chamber that temporarily stores ink that has been deaerated by the deaeration module 451. The capacity of the second sub-tank 43 is substantially the same as that of the first sub-tank 42, for example. The second sub-tank 43 is connected to the inlet of each of the inkjet head 24a via a supply path 46. The ink in the second sub-tank 43 is supplied to each of the inkjet head 24a according to the amount of ink to be discharged from the nozzle. Further, the second sub-tank 43 is provided with a back pressure adjusting means (not illustrated) for preventing the ink from leaking out by applying an appropriate negative pressure to the inkjet head 24a.

### <Supply Tube>

The supply tube 44 is an ink channel that communicates with the main tank 41 and the first sub-tank 42. The supply pipe 44 is provided with a supply pump 441 and a supply valve 442. The supply pump 441 and the supply valve 442 operate under the control of the controller 50. The ink in the main tank 41 is supplied to the first sub-tank 42 via the supply pipe 44 by driving of the supply pump 441 when the supply valve 442 is opened. The entire main tank 41 is replaceable. Further, the main tank 41 can be attached to and detached from the supply pipe 44 regardless of the driving state of the supply pump 441.

### <Liquid Delivery Tube>

The liquid delivery tube 45 is an ink channel that allows the first sub-tank 42 and the second sub-tank 43 to communicate with each other. The liquid delivery tube 45 is provided with a deaeration module 451, a sensor 452, a liquid delivery pump 453, a liquid delivery valve 454, and the like.

### <Deaeration Module>

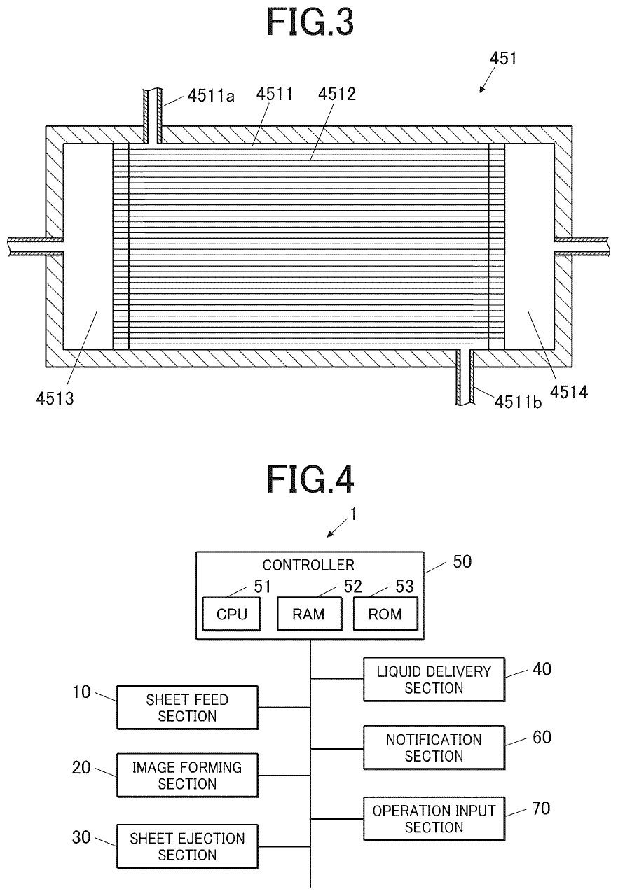

FIG. 3 shows an enlarged cross-sectional view of the deaeration module 451. The deaeration module 451 removes dissolved gas in the ink that has flowed thereinto, and discharges the deaerated ink. The deaeration module 451 includes an ink flow chamber 4511, a gas permeable membrane 4512, a first vacuum chamber 4513, a second vacuum chamber 4514, and the like.

### {Ink Flow Chamber}

The ink flow chamber 4511 is provided in a central portion of the inside of the casing forming the deaeration module 451. The ink flow chamber 4511 includes an ink inflow port 4511a and receives inflow of the ink before degassing from the first sub-tank 42. In addition, the ink flow chamber 4511 includes an ink outflow port 4511b, and the deaerated ink flows out to the second sub-tank 43.

Note that as illustrated in FIG. 3, the ink inflow port 4511a and the ink outflow port 4511b are preferably provided on a first end side and a second end side opposite to the first end side of the ink flow chamber 4511, respectively. In particular, as illustrated in FIG. 3, it is more preferable that the ink inflow port 4511a and the ink outflow port 4511b are provided on a substantially diagonal line of the ink flow chamber 4511. According to the above-described configuration, the ink comes into contact with the gas permeable membrane 4512 more easily, and the deaeration efficiency of the deaeration module 451 can be increased.

### {Gas Permeable Membrane}

The gas permeable membrane 4512 includes a tubular shape, and its membrane surface has gas permeability. The gas permeable membrane 4512 is, for example, a hollow fiber membrane, has a large number of hollow fine yarn structures, and is arranged such that the large number of hollow fine yarn structures form a bundle and extend in the axis direction of the ink flow chamber 4511.

In addition, as illustrated in FIG. 3, the gas permeable membrane 4512 is disposed so as to allow the first vacuum chamber 4513 and the second vacuum chamber 4514 to communicate with each other. Therefore, the first end of the gas permeable membrane 4512 is connected to the atmosphere via a first atmospheric valve 472 to be described later. In addition, in the gas permeable membrane 4512, a second end opposite to the first end communicates with a vacuum pump 485 which will be described later.

Note that the gas permeable membrane 4512 is preferably made of, for example, silicone. This is because silicone has a high ability to transmit the dissolved gas in the ink. This is also because silicone has high heat resistance and ink resistance.

### {First Vacuum Chamber}

The first vacuum chamber 4513 is provided at the first end of the deaeration module 451. The first vacuum chamber 4513 is formed by being partitioned from the ink flow chamber 4511 by a partition wall. The side of the first vacuum chamber 4513 facing the ink flow chamber 4511 is connected to the atmosphere by a first vacuum path 47 described below.

### {Second Vacuum Chamber}

The second vacuum chamber 4514 is provided on the second end side of the deaeration module 451 facing the first vacuum chamber 4513. The second vacuum chamber 4514 is formed by being partitioned from the ink flow chamber 4511 by the partition wall. The second vacuum chamber 4514 communicates with the liquid storage section 482 via a second vacuum path 48 described later.

Although the form of the deaeration module 451 is not particularly limited, for example, it is preferable to use a sheet in which a plurality of gas permeable membranes 4512 are woven into a mesh shape. With the above-described configuration, pores of the gas permeable membrane 4512 become fine, all the ink easily passes through the pores of the gas permeable membrane 4512, and the deaeration efficiency is easily increased. Furthermore, with the above-described configuration, even a flexible gas permeable membrane 4512 is likely to have a certain strength or more.

### <Flow Rate Sensor>

Returning to FIG. 2, the flow rate sensor 452 is provided in the vicinity of the deaeration module 451 on the liquid delivery tube 45. The flow rate sensor 452 detects a flow rate of the ink flowing through the liquid delivery tube 45 and transmits the flow rate to the controller 50. Note that FIG. 2 illustrates, as an example, the configuration in which the flow rate sensor 452 is provided on the downstream of the deaeration module 451 in a liquid delivery direction, but the configuration is not limited thereto. The flow rate sensor 452 may be provided on the upstream of the deaeration module 451 in the liquid delivery direction.

<Liquid Delivery Pump, Liquid Delivery Valve>The liquid delivery pump 453 and the liquid delivery valve 454 operate under the control of the controller 50. The liquid delivery pump 453 sends out, to the second sub-tank 43, the ink having flowed out from the ink outflow port 4511b of the deaeration module 451 when the liquid delivery valve 454 is opened. A check valve (not illustrated) is provided between the liquid delivery pump 453 and the second sub-tank 43 to prevent backflow of the ink sent to the second sub-tank 43.

### <First Vacuum Path>

The first vacuum path 47 is a channel that communicates with the first vacuum chamber 4513 at the first end of the deaeration module 451. The first vacuum path 47 is provided with a first pressure sensor 471, a first atmospheric valve 472, and the like.

### <First Pressure Sensor, First Atmospheric Valve>

The first pressure sensor 471 detects a pressure value in the first vacuum chamber 4513 and transmits the pressure value to the controller 50. The first atmospheric valve 472 is an electromagnetic valve. The first atmospheric valve 472 opens or closes the first vacuum path 47 to the atmosphere in response to a control signal from the controller 50.

### <Second Vacuum Path>

The second vacuum path 48 is an air channel that communicates with the second vacuum chamber 4514 at the second end of the deaeration module 451. The second vacuum path 48 is provided with an ink leakage sensing section 481, a liquid storage section (liquid storage) 482, a second pressure sensor 483, a second atmospheric valve 484, a vacuum pump 485, and a discharge channel 486.

### <Ink Leakage Sensing Section>

The ink leakage sensing section 481 detects the ink mistakenly having passed through the gas permeable membrane 4512. Specifically, the ink leakage sensing section 481 is formed of a photosensor, and has a light emitting section and a light receiving section interposing the second vacuum path 48. When the gas permeable membrane 4512 is damaged, the ink having entered the gas permeable membrane 4512 adheres to the inner side of the second vacuum path 48. When a light reception state changes due to the ink adhered to the second vacuum path 48, the ink leakage sensing section 481 detects ink leakage.

### <Liquid Storage Section>

The liquid storage section 482 is capable of storing a predetermined volume of gas, and suppresses pressure fluctuation in the gas permeable membrane 4512 due to pulsation of the vacuum pump 485.

In addition, the liquid storage section 482 stores therein the liquid component of the ink which infiltrates into the gas permeable membrane 4512 and enters the second vacuum path 48. The liquid component stored in the liquid storage section 482 is a monomer, for example, when the ink is UV ink. The liquid component stored in the liquid storage section 482 is discharged to the discharge channel 486 at a predetermined timing, thereby preventing the liquid storage section 482 from becoming full of the liquid component and the overflowing liquid component from reaching the vacuum pump 485 and causing a malfunction.

### <Second Pressure Sensor, Second Atmospheric Valve>

The second pressure sensor 483 is provided between the liquid storage section 482 and the vacuum pump 485 in the second vacuum path 48, and sequentially transmits a detected pressure value to the controller 50. The second atmospheric valve 484 is normally in a closed state, and is brought into an open state when the vacuum pump 485 is driven under the control of the controller 50.

### <Vacuum Pump>

The vacuum pump 485 is, for example, a diaphragm pump. Specifically, the vacuum pump 485 includes a pump chamber having an extendable diaphragm. In addition, the vacuum pump 485 includes an operation source or the like that operates the diaphragm so that the volume of the pump chamber expands and contracts. The pump chamber includes a suction port having the check valve that allows only inflow of a fluid from the outside. The pump chamber also includes a discharge port having the check valve that allows only outflow of the fluid from the inside.

Under the control of the controller 50, the vacuum pump 485 sucks in the atmosphere in the gas permeable membrane 4512 when the first atmospheric valve 472 is closed and the second atmospheric valve 484 is opened. By the operation of the vacuum pump 485, a foreign substance in the gas permeable membrane 4512 is removed, and the pressure in the gas permeable membrane 4512 is reduced. Therefore, in the ink which flows into the ink flow chamber 4511 and comes into contact with an outer film surface of the gas permeable membrane 4512, the dissolved gas selectively permeates the film surface and is deaerated. Then, the dissolved gas that has passed through the gas permeable membrane 4512 is discharged by the vacuum pump 485 via the second vacuum chamber 4514.

### <Discharge Channel>

The discharge channel 486 is a channel provided so as to communicate with a lower portion of the liquid storage section 482 in the liquid delivery section 40 of each color, and is a liquid channel through which the liquid component stored in each liquid storage section 482 is discharged. The discharge channel 486 is provided with a discharge valve 4861, a liquid heating section (liquid heater) 4862, a liquid discharge section 4863, a pressure detector 4864, and a suction pump 4865.

### {Discharge Valve}

The discharge valve 4861 is normally in a closed state and is opened by the controller 50 at a timing of liquid component discharge processing described later.

### {Liquid Heating Section}

The liquid heating section 4862 suppresses clogging of the discharge channel 486 with the liquid component by heating the discharge channel 486. FIG. 2 illustrates the case where the liquid heating section 4862 is formed of a heat transfer member that transfers heat from the heater, but the liquid heating section 4862 may be, for example, the heater itself. As the heater constituting the ink heating section, a heating wire that generates Joule heat by energization is used, for example. As the ink heating section constituting the ink heating section, a member having high heat conductivity, for example, a heat conductive plate formed of various metals (alloys) is used.

### {Liquid Discharge Section}

The liquid discharge section 4863 is directly connected to the discharge channel 486, and the liquid component discharged from the liquid storage section 482 of each color ink is discharged. The liquid discharge section 4863 is constituted by, for example, a plastic bottle. Note that while the liquid storage section 482 needs to be located inside the inkjet recording apparatus 1 and between the deaeration module 451 and the vacuum pump 485, the liquid discharge section 4863 needs only to communicate with the liquid storage section 482 via the liquid discharge channel 486. Therefore, the liquid discharge section 4863 can be installed in any place such as the outside of the inkjet recording apparatus 1, for example, and the capacity of the liquid discharge section 4863 can be set to be larger than the capacity of the liquid storage section 482. To be specific, for example, the capacity of the liquid storage section 482 is about 200 ml, and the capacity of the liquid discharge section 4863 is about 1000 ml.

### {Pressure Detector, Suction Pump}

The pressure detector 4864 detects the pressure value of the discharge channel 486, and sequentially transmits a detection result to the controller 50. The suction pump 4865 has substantially the same configuration as the vacuum pump 485 and reduces the pressure in the discharge channel 486.

### (Controller)

FIG. 4 is a block diagram illustrating a configuration of the inkjet recording apparatus 1. The controller 50 controls the components constituting the inkjet recording apparatus 1. As shown in FIG. 4, the controller 50 is connected to each section constituting the inkjet recording apparatus 1. The controller 50 includes a central processing unit (CPU) 51, a random access memory (RAM) 52, and a read only memory (ROM) 53.

### <CPU, RAM, ROM>

The CPU 51 reads various programs and data corresponding to processing contents from the storage device of the ROM 53 or the like and executes them. Further, the CPU 51 controls the operation of the components constituting the inkjet recording apparatus 1 according to the contents of the executed processing. The RAM 52 temporarily stores therein the various programs and data processed by the CPU 51. The ROM 53 stores various programs and data, which are read by the CPU 51 or the like.

### (Notification Section)

The notification section 60 provides notification of various types of information under the control of the controller 50. The notification section 60 is, for example, a display part having a screen, a communication section capable of communicating with another device via a network, or the like.

(operation Input Section)

The operation input section 70 accepts various inputs related to the operation of the inkjet recording apparatus 1 according to the user's operation. The operation input section 70 includes, for example, a touch screen type input display device, up, down, left, and right movement keys for data selection, feed operation, and the like, various function keys, and the like. The operation input section 70 outputs a depression signal of a key depressed by the user or an operation signal of a mouse or the like to the CPU 51 of the controller 50.

### Liquid Component Discharge Processing

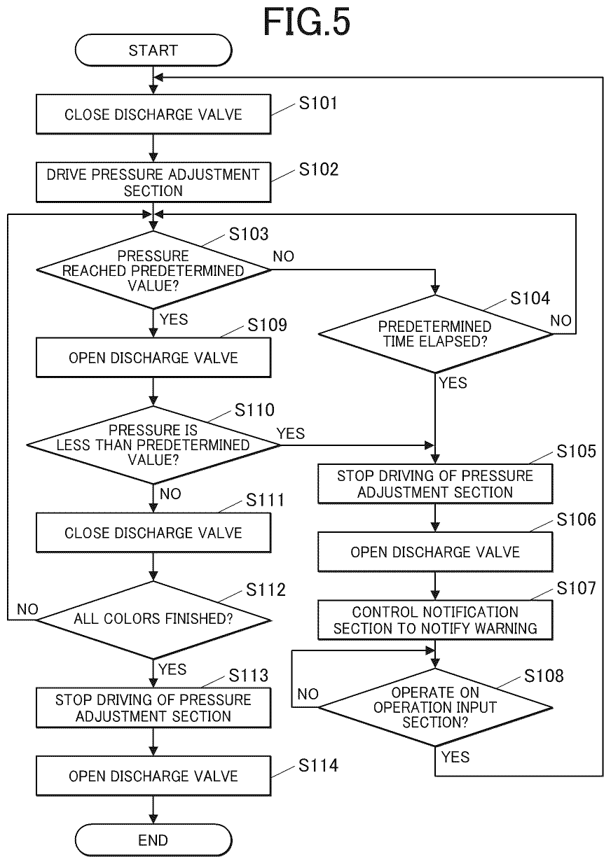

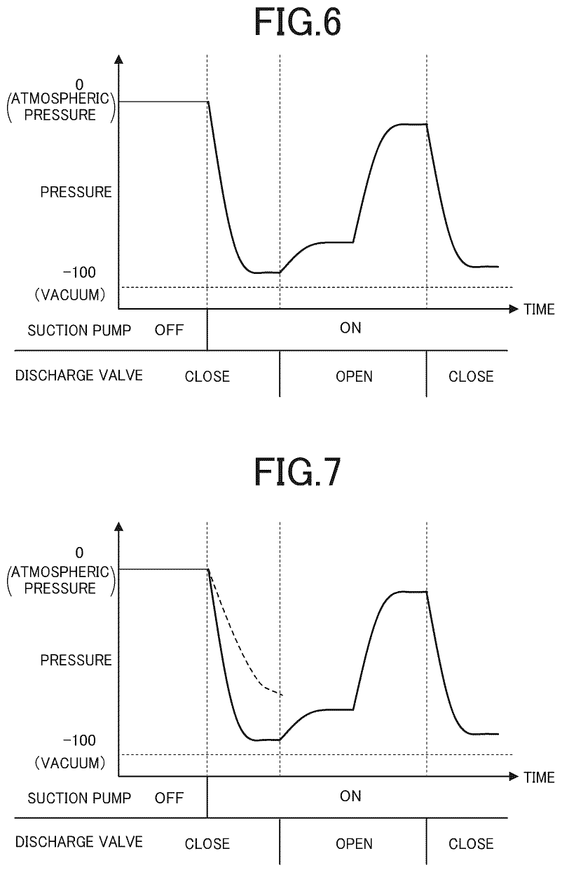

The liquid component discharge processing by the controller 50 will be described with reference to the flowchart of FIG. 5 and the graphs of FIG. 6 to FIG. 8. The liquid component discharge processing is processing of providing a pressure difference between the liquid storage section 482 and the discharge channel 486 by a pressure adjustment section (pressure adjuster) to thereby discharge the liquid component stored in the liquid storage section 482 to the discharge channel 486. FIG. 6 is a graph showing a change in the pressure value of the normal discharge channel 486 measured by the pressure detector 4864 in the liquid component discharge processing. The controller 50 executes the liquid component discharge processing, for example, at timing at which a predetermined amount of the liquid component is estimated to be stored in the liquid storage section 482.

First, the controller 50 closes the discharge valve 4861 (step S101). The controller 50 drives the suction pump 4865 serving as the pressure adjustment section to depressurize the discharge channel 486 (step S102). The controller 50 determines whether the detection result of the pressure detector 4864 decreased to a predetermined value (step S103). When the detection result of the pressure detector 4864 has not decreased to the predetermined value (step S103; No), the controller 50 determines whether or not a predetermined amount of time has elapsed (step S104). In a case where the predetermined time has not elapsed (step S104; No), the controller 50 transitions to step S103, and continuously waits until the detection result of the pressure detector 4864 decreases to a predetermined value.

In the normal liquid component discharge processing, since the suction pump 4865 is driven in a state where the discharge valve 4861 is closed, the detection result of the pressure detector 4864 decreases as shown by the solid line in FIG. 6. On the other hand, when the discharge channel 486 has a leakage, the pressure value of the discharge channel 486 is less likely to decrease than in the normal state, although depending on the degree of the leakage and the suction force of the suction pump 4865. Therefore, it takes more time for the pressure value of the discharge channel 486 to decrease completely than in the normal state. Alternatively, as illustrated by a dotted line in FIG. 7, the pressure value of the discharge channel 486 does not completely decrease to the predetermined value.

Therefore, if the predetermined time has elapsed without the detection result of the pressure detector 4864 decreasing to the predetermined value (step S104; Yes), in other words, if a pressure decreasing speed of the discharge channel 486 is less than the predetermined value, the controller 50 determines that the discharge channel 486 has the leakage.

If the controller 50 determines that an abnormality, such as the leakage, has occurred in the discharge channel 486, the controller 50 proceeds to an error processing sequence. The controller 50 stops the driving of the suction pump 4865 (step S105), opens the discharge valve 4861 (step S106), causes the notification section 60 to notify that the discharge channel 486 has an abnormality (step S107), and waits for the user to respond. When a response completion signal is input from the user by the operation of the operation input section 70 (step S108; Yes), the controller 50 ends the error processing sequence and transitions to step S101 in order to resume the liquid component discharge processing.

In a case where the discharge channel 486 does not have the leakage and the detection result of the pressure detector 4864 decreases to the predetermined value (step S103; Yes), the controller 50 opens the discharge valve 4861 (step S109). At this time, the liquid storage section 482 is in communication with the open first atmospheric valve 472, and therefore is at atmospheric pressure. On the other hand, the discharge channel 486 has a negative pressure as described above, and the suction pump 4865 is also being driven. Therefore, due to the pressure difference, the liquid component in the liquid storage section 482 is drawn into the discharge channel 486 and discharged to the liquid discharge section 4863.

After a predetermined amount of time, the controller 50 determines whether the detection result of the pressure detector 4864 is less than a predetermined value (step S110). In the normal liquid component discharge processing, when the liquid component in the liquid storage section 482 is discharged to the liquid discharge section 4863 of the discharge channel 486, air is drawn in from the first atmospheric valve 472 which communicates with the liquid storage section 482. Therefore, the detection result of the pressure detector 4864 increases toward the atmospheric pressure as indicated by the solid line in FIG. 6. In contrast, in a case where the discharge channel 486 is clogged, it takes longer time than usual from the opening of the discharge valve 4861 until the liquid component in the liquid storage section 482 is discharged. Therefore, it takes time until the pressure value of the discharge channel 486 starts to rise. In addition, even if the liquid component is discharged, the inflow amount of air decreases compared from usual. Therefore, as illustrated by the dotted line in FIG. 8, the pressure value of the discharge channel 486 becomes stable at a low value. Therefore, when the detection result of the pressure detector 4864 after the predetermined time from the opening of the discharge valve 4861 is less than the predetermined value (step S110; Yes), the controller 50 determines that the discharge channel 486 is clogged. Then, the controller 50 shifts to the error processing sequence, that is, step S105.

In this manner, the controller 50 functions as a determination section which determines, based on the detection result of the pressure detector 4864, whether or not the discharge of the liquid component from the liquid storage section 482 to the discharge channel 486 is performed normally.

In a case where the discharge channel 486 is not clogged and the detection result of the pressure detector 4864 is equal to or greater than the predetermined value (step S110; No), the controller 50 determines that the liquid component in the liquid storage section 482 is discharged normally. Therefore, the controller 50 closes the discharge valve 4861 (step S111), and determines whether or not the liquid component is discharged from the liquid storage section 482 of the ink of all colors (step S112). In a case where the liquid component is not discharged from the liquid storage section 482 of all colors of ink (step S112; No), the controller 50 transitions to step S103 and performs pressure adjustment again. In a case where the liquid component is discharged from the liquid storage section 482 of the inks of all the colors (step S112; Yes), the controller 50 stops the driving of the suction pump 4865 (step S113), and ends the liquid component discharge processing.

### Modification Example and the Like

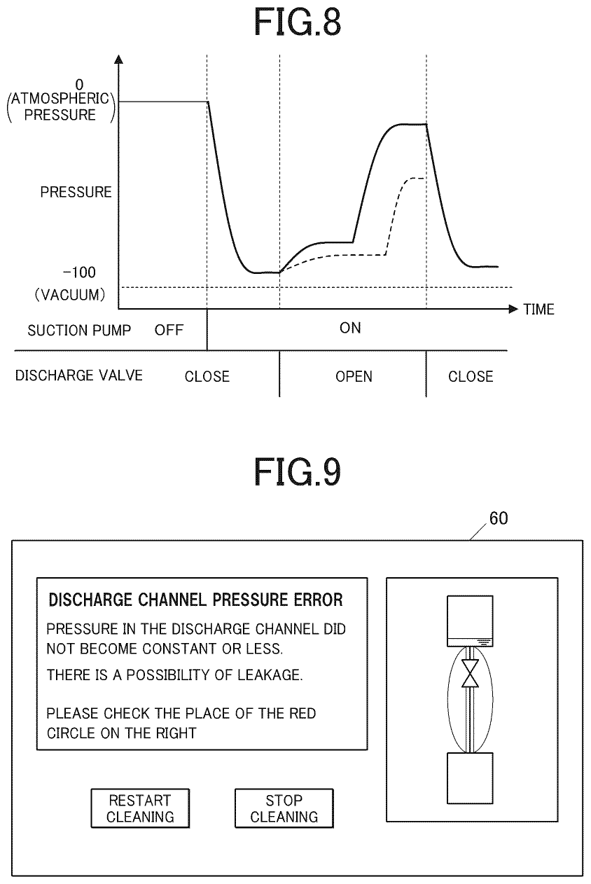

As shown in FIG. 9, for example, the controller 50 may cause the notification section 60 to notify whether or not it is determined in step S107 that an abnormality has occurred in any of the portions. With the above configuration, the user can know from which part the presence or absence of abnormality should be confirmed. Therefore, the downtime required for the liquid component discharge processing can be reduced, and a decrease in productivity can be further suppressed.

Furthermore, although the configuration in which the liquid component is sequentially discharged from the liquid storage section 482 of the respective colors of ink in step S112 has been illustrated in the above, it is not limited thereto. For example, in a case where the suction force of the suction pump 4865 is sufficient, the liquid component in each liquid storage section 482 may be collectively discharged. Alternatively, in a case where there is sufficient space in the inkjet recording apparatus 1 or the like, the discharge channel 486 may be individually provided for each of the liquid storage sections 482, and the liquid components in each of the liquid storage sections 482 may be discharged in parallel to reduce downtime.

In addition, in the above description, a configuration in which the liquid components of all of the liquid storage sections 482 are sequentially discharged in one liquid component discharge processing is exemplified, but the invention is not limited thereto. For example, in a case where it is estimated that a predetermined amount of the liquid component has been stored in some of the liquid storage sections 482 but it is estimated that there is still room in the other liquid storage sections 482, the liquid component may be discharged from only the above-described some of the liquid storage sections 482 to reduce the downtime.

### Effects of First Embodiment

As described above, the inkjet recording system 100 according to the present embodiment includes the suction pump 4865 that functions as the pressure adjustment section to discharge the liquid component to the liquid discharge section 4863 of the discharge channel 486 by depressurizing the liquid storage section 482. According to the above-described configuration, the liquid component in the liquid storage section 482 can be removed without requiring time and effort of the user, and an increase in cost and a decrease in productivity can be suppressed.

In addition, the inkjet recording system 100 includes the pressure detector 4864 which detects the pressure value of the discharge channel 486. Next, the controller 50 determines, based on the detection result of the pressure detector 4864, whether or not the discharge of the liquid component from the liquid storage section 482 to the discharge channel 486 is being performed normally. According to the configuration, it is possible to prevent the liquid component from overflowing from the liquid storage section 482, assuming that the liquid component has been discharged although the discharge of the liquid component from the liquid storage section 482 to the discharge channel 486 is not sufficiently performed.

Furthermore, the inkjet recording system 100 includes the discharge valve 4861 that can open and close the discharge channel 486 under the control of the controller 50. Then, if the pressure value in the discharge channel 486 at a predetermined time after depressurization of the discharge channel 486 by the suction pump 4865 and after opening of the discharge valve 4861 is less than a predetermined value, the controller 50 determines that the discharge channel 486 is clogged. According to the configuration, it is possible to suppress the overflow of the liquid component from the liquid storage section 482 due to the clogging of the discharge channel 486.

Furthermore, the inkjet recording system 100 includes the discharge valve 4861 that can open and close the discharge channel 486 under the control of the controller 50. Then, when the discharge valve 4861 is closed and the pressure decreasing speed in the pressure value in the discharge channel 486 during driving of the suction pump 4865 is less than the predetermined value, the controller 50 determines that there is the leakage in the discharge channel 486. According to the configuration, it is possible to suppress the overflow of the liquid component from the liquid storage section 482 due to the leakage of the discharge channel 486.

In addition, the inkjet recording system 100 includes a notification section 60 which notifies the user of a warning according to the determination of the controller 50. With the above-described configuration, in a case where there is the abnormality in the discharge channel 486, the user can be made aware of the abnormality and handle it.

Further, the notification section 60 displays a portion to be checked by the user according to the determination of the controller 50. According to the above configuration, the user can cope with the abnormality more quickly, and the downtime associated with the abnormality coping can be reduced.

The discharge channel 486 further includes the liquid heating section 4862 to heat the liquid component. According to the configuration, it is possible to suppress the occurrence of clogging of the liquid component in the discharge channel 486.

In the inkjet recording system 100, the ink is the ink containing a gelling agent, and the liquid component is a monomer. In the above-described configuration, since the monomer is likely to be accumulated in the liquid storage section 482, the configuration of the present invention particularly functions effectively.

### Second Embodiment

Next, the inkjet recording system 100 according to a second embodiment will be described. In addition, the same reference numerals are given to configurations common to those of the inkjet recording system 100 according to the first embodiment, and detailed description thereof will be omitted.

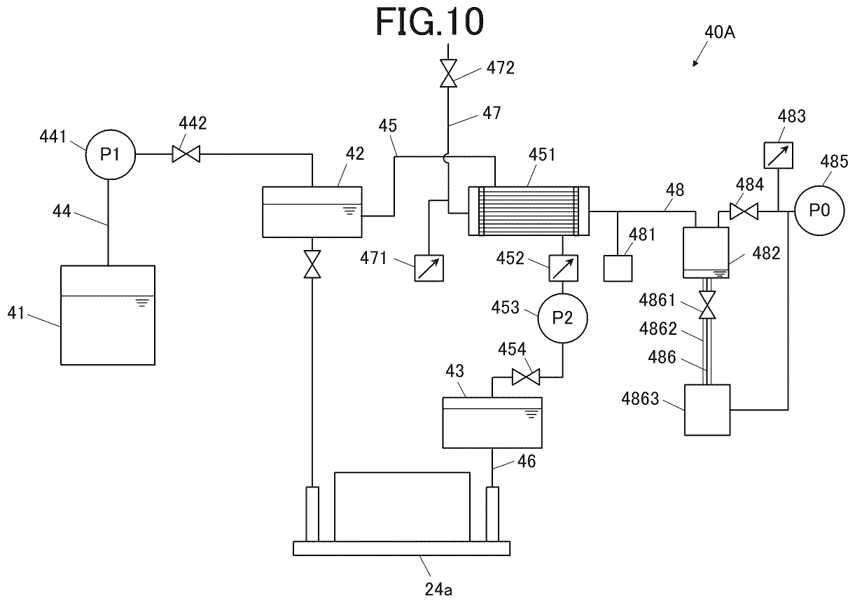

FIG. 10 is a schematic diagram of a liquid delivery section 40A of the inkjet recording system 100 according to the second embodiment. The inkjet recording system 100 according to the second embodiment does not include the suction pump 4865.

Specifically, as illustrated in FIG. 10, the inkjet recording system 100 according to the second embodiment includes an air channel that communicates between a point between the second atmospheric valve 484 and the vacuum pump 485 in the second vacuum path 48 and the liquid discharge section 4863. Next, when the discharge channel 486 is depressurized, the second atmospheric valve 484 is closed, the vacuum pump 485 is driven, and it is determined, based on the detection value of the second pressure sensor 483, whether or not the control of each portion and the liquid component discharge processing are normally performed. That is, in the second embodiment, the vacuum pump 485 functions as the pressure adjustment section which provides a pressure difference between the liquid storage section 482 and the discharge channel 486.

### Effects of Second Embodiment

As described above, in the inkjet recording system 100 according to the present embodiment, the vacuum pump 485 that communicates with the deaeration module 451 to evacuate the inside of the gas permeable membrane 4512 functions as the pressure adjustment section. Although the liquid component discharge processing can be normally performed also in the above-described configuration, it is not particularly necessary to separately provide the pressure detector 4864 and the suction pump 4865, and hence the cost of the inkjet recording system 100 can be reduced.

### Third Embodiment

Next, the inkjet recording system 100 according to the third embodiment will be described. Note that common constituent elements have the same reference numerals as those of the inkjet recording system 100 according to the first and second embodiments, and the detailed description of the common constituent elements is omitted.

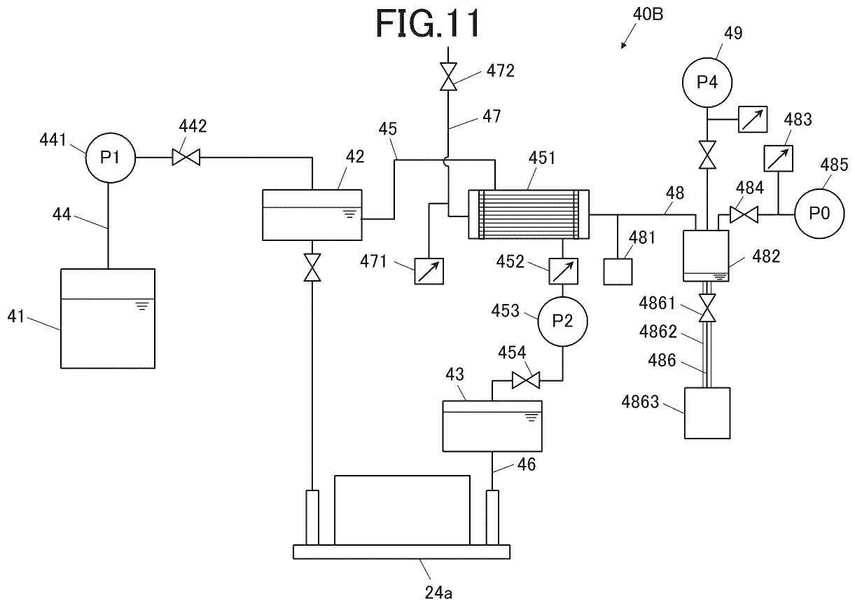

FIG. 11 is a schematic diagram of a liquid delivery section 40B of the inkjet recording system 100 according to the third embodiment. The inkjet recording system 100 according to the third embodiment does not include the suction pump 4865, and a pneumatic pump 49 functions as the pressure adjustment section.

Specifically, the inkjet recording system 100 according to the third embodiment is provided with a known air channel that communicates with each liquid storage section 482. The air channel is provided with a known electromagnetic valve, a pressure sensor, and the pneumatic pump 49. The pneumatic pump 49 is a pressure pump that pressurizes the air channel and the liquid storage section 482. The controller 50 discharges the liquid component to the discharge channel 486 by opening the discharge valve 4861 at a timing when the pressure value of the liquid storage section 482 is increased to a predetermined value by driving the pneumatic pump 49.

### Effects of Third Embodiment

As described above, in the inkjet recording system 100 according to the present embodiment, the pneumatic pump 49 which pressurizes the inside of the liquid storage section 482 functions as the pressure adjustment section. Although the liquid component discharge processing can be normally performed also in the above-described configuration, in particular, in the above-described configuration, the pressure adjustment of the discharge channel 486 including the liquid discharge section 4863 becomes unnecessary. Therefore, it is not necessary to have a configuration in which the liquid discharge section 4863 is directly connected to the discharge channel 486, and for example, it is possible to use a tub or the like which is a separate body from the discharge channel 486 and the inkjet recording apparatus 1, and the degree of freedom of design is increased.

### Fourth Embodiment

Next, the inkjet recording system 100 according to the fourth embodiment will be described. Note that common constituent elements have the same reference numerals as those of the inkjet recording system 100 according to the first to third embodiment, and the detailed description of the common constituent elements is omitted.

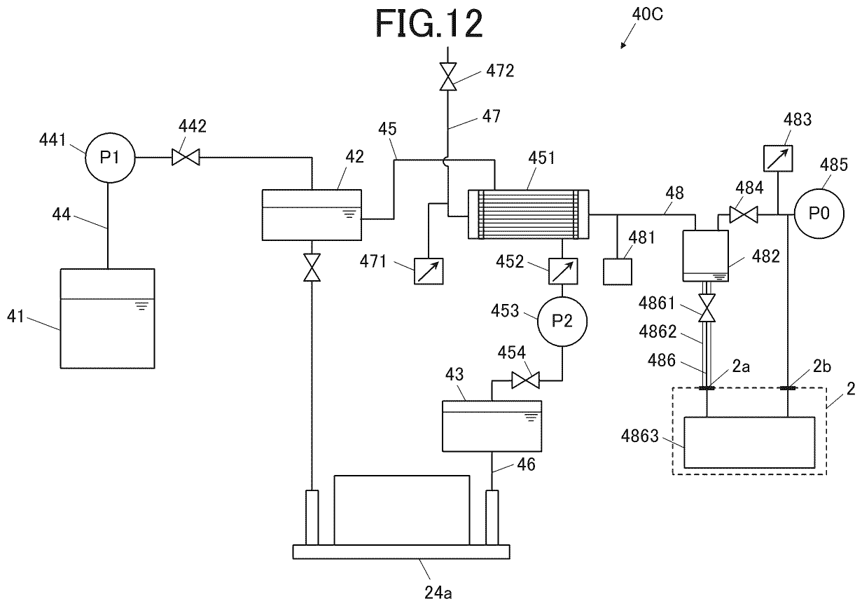

FIG. 12 is a schematic diagram of the liquid delivery section 40C of the inkjet recording system 100 according to the fourth embodiment. The inkjet recording system 100 according to the fourth embodiment includes the cleaning jig 2 which is a separate body from the inkjet recording apparatus 1 and becomes a part of the discharge channel 486 at the time of connection.

The cleaning device 2 includes the liquid discharge section 4863, the first fitting 2a, and the second fitting 2b. The first fitting 2a is provided in a manner detachable from the discharge channel 486. The second fitting 2b is detachably provided between the second pressure sensor 483 and the vacuum pump 485 in the second vacuum path 48. In the above-described configuration, similarly to the second embodiment illustrated in FIG. 10, the vacuum pump 485 functions as the pressure adjustment section.

### Liquid Component Discharge Processing

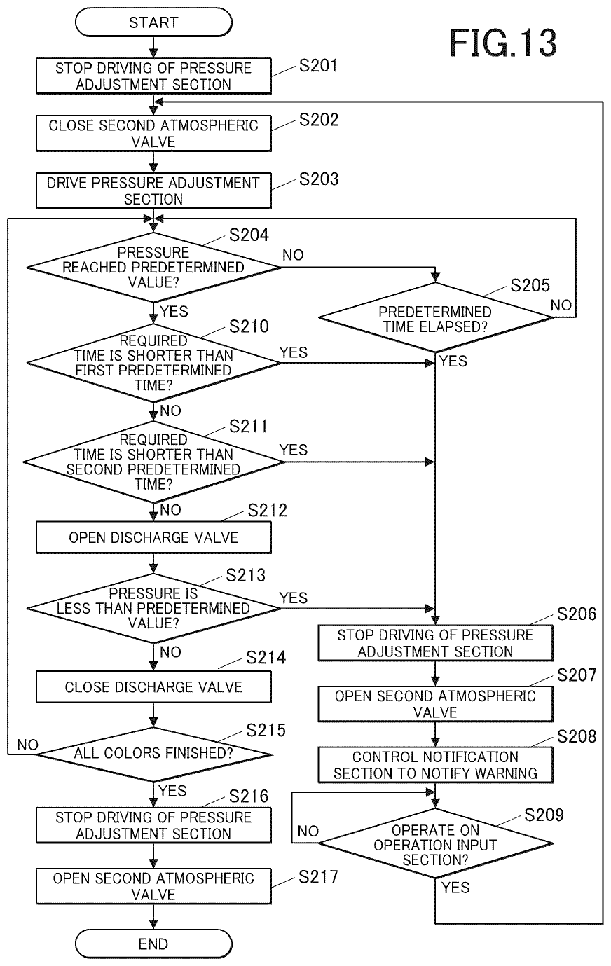

FIG. 13 shows a flowchart of the liquid component discharge processing in the inkjet recording system 100 including such a cleaning jig 2. Note that in the following description, step S202 to step S209 and step S212 to step S217 are substantially the same as step S101 to step S108 and step S109 to step S114 in the flowchart illustrated in FIG. 5, and thus detailed description thereof will be omitted.

First, the controller 50 stops driving the vacuum pump 485 serving as the pressure adjustment section (step S201) and closes the second atmospheric valve 484 (step S202). After closing of the second atmospheric valve 484, the controller 50 drives the vacuum pump 485 (step S203).

The controller 50, by driving the vacuum pump 485, waits until the second pressure sensor 483 detects the predetermined value (step S204 and step S205). If the second pressure sensor 483 does not detect the predetermined value (step S205; Yes), the controller 50 determines that there is the leakage, and proceeds to the error processing sequence (steps S206 to S209).

If the second pressure sensor 483 detects the predetermined value (step S204; Yes), the controller 50 determines whether or not the time required for the detection result of the second pressure sensor 483 to become the predetermined value from the driving of the vacuum pump 485 is shorter than a first predetermined time (step S210). If the time is equal to or longer than the first predetermined time (step S210; No), it is determined whether or not the time is shorter than a second predetermined time that is longer than the first predetermined time (step S211).

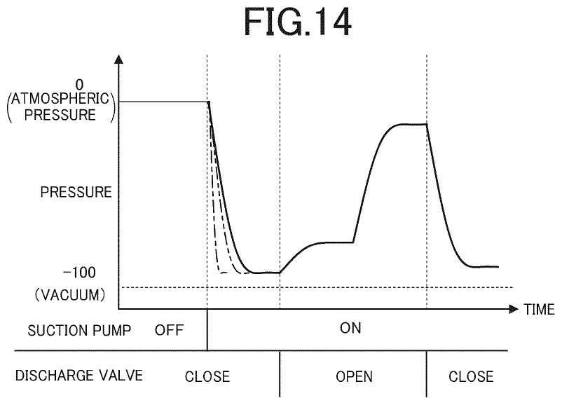

In the normal liquid component discharge processing, since the vacuum pump 485 is driven with the second atmospheric valve 484 being closed, the detection result of the second pressure sensor 483 decreases as illustrated in FIG. 6. In contrast, in a case where the first fitting 2a or the second fitting 2b has a connection failure due to partial connection or forgetting to connect, the volume of the space sucked by the vacuum pump 485 becomes smaller than in a normal state. For example, in a case where the first fitting 2a has a poor connection, the volume of the space sucked by the vacuum pumps 485 decreases by the space from the discharge valve 4861 to the first fitting 2a in the discharge channel 486. In addition, in a case where there is a connection failure in the second fitting 2b, the volume of the space sucked by the vacuum pump 485 is further reduced by the liquid discharge section 4863 and the amount from the liquid discharge section 4863 to the second fitting 2b. Therefore, as indicated by the dash dot line and the dash dot dot line in FIG. 14, respectively, the time required for the result of detection by the pressure detector 4864 to reach the predetermined value is shorter than in the normal state.

Therefore, when the time required for the detection result of the pressure detector 4864 to become the predetermined value from the driving of the vacuum pump 485 is shorter than the first predetermined time (step S210; Yes), the controller 50 determines that the connection of the second fitting 2b is faulty, and proceeds to step S206. If the time required for the detection result of the pressure detector 4864 to become the predetermined value from the driving of the vacuum pump 485 is less than the second predetermined time that is longer than the first predetermined time (step S211; Yes), the controller 50 determines that the connection of the first fitting 2a is faulty and transitions to step S206.

If the time required for the detection result of the pressure detector 4864 to become the predetermined value from the driving of the vacuum pump 485 is longer than or equal to the second predetermined time (step S211; No), the controller 50 determines that no connection failure of the cleaning jig 2 exists. Therefore, the controller 50 opens the discharge valve 4861 (step S212). By the opening of the second atmospheric valve 484 and the pressure difference between the liquid storage section 482 and the discharge channel 486 (cleaning jig 2), the liquid component in the liquid storage section 482 is discharged to the liquid discharge section 4863 of the discharge channel 486.

Subsequent step S213 to step S217 are substantially the same as step S110 and step S114, and thus detailed description thereof will be omitted.

### Effects of Fourth Embodiment

As described above, the inkjet recording system 100 according to the present embodiment includes the cleaning jig 2 that is separate from the inkjet recording apparatus 1 and is detachably attached to the discharge channel 486. In addition, in the inkjet recording system 100, the vacuum pump 485 which communicates with the deaeration module 451 and evacuates the inside of the gas permeable membrane 4512 is a pressure adjustment section. According to the above-described configuration, similarly to the second embodiment, since it is not necessary to separately provide the pressure detector 4864 and the suction pump 4865, it is possible to reduce the cost of the inkjet recording system 100. Furthermore, similarly to the third embodiment, since the liquid discharge section 4863 can be provided separately from the inkjet recording apparatus 1, the degree of freedom in design can be increased.

### Leakage Spot Identification Processing

Note that in the above description, in the case of transitioning from step S205 to step S206, in step S208, the occurrence of leakage is simply notified, but the present invention is not limited thereto, and the range of leakage occurrence may be specified by having the user perform the leakage spot identification processing.

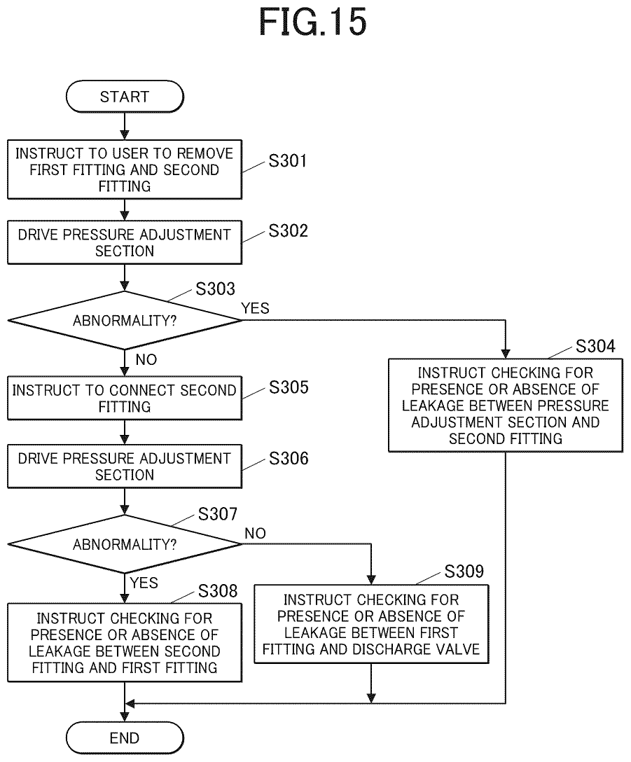

A flowchart related to the leakage spot identification processing is illustrated in FIG. 15. First, the controller 50 causes the notification section 60 to disconnect the first fitting 2a and the second fitting 2b of the cleaning jig 2 from the second vacuum path 48 (step S301). Upon accepting the signal that the first fitting 2a and the second fitting 2b are removed by an operation of the operation input section 70 by the user, the controller 50 drives the vacuum pump 485 (step S302). The controller 50 determines whether or not the detection result of the second pressure sensor 483 is the abnormality (step S303). When there is the abnormality (step S303; Yes), the controller 50 instructs the user to check for the leakage between the vacuum pump 485 and the second fitting 2b by the notification section 60 (step S304).

If there is no abnormality (step S303; No), the controller 50 connects the second fitting 2b (step S305) and drives the vacuum pump 485 (step S306). Next, the controller 50 determines whether or not the detection result of the second pressure sensor 483 is the abnormality (step S307). If there is the abnormality (step S307; Yes), the controller 50 instructs, with the notification section 60, the user to check for the leakage between the second fitting 2b and the liquid discharge section 4863 (step S308). In a case where there is no abnormality (step S307; No), the controller 50 instructs the user to check the leakage between the liquid discharge section 4863 and the first fitting 2a by the notification section 60 (step S309).

Performing such processing can narrow the range of leakage occurrence, thus allowing the user to more easily identify the leakage spot and reducing the downtime required for leakage processing.

Although some embodiments of the present invention have been described above, the scope of the present invention is not limited to the above-described embodiments, and includes the scope of the invention described in the claims and the scope of equivalents thereof.

For example, in the above description, the inkjet recording apparatus 1 including the sheet feed section 10, the image forming section 20, the sheet ejection section 30, the liquid delivery section 40, the controller 50, the notification section 60, and the operation input section 70 is exemplified, but the invention is not limited thereto. In the inkjet recording system 100, the inkjet recording apparatus 1 only needs to include the image forming section 20, and other components may be included in another apparatus separate from the inkjet recording apparatus 1.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An inkjet recording system that forms an image by ejecting ink from an inkjet head, the inkjet recording system comprising:
a deaeration module including a gas permeable membrane that can deaerate a dissolved gas in the ink having external contact; and
a liquid storage that communicates with the gas permeable membrane and that stores a liquid component of the ink having permeated the gas permeable membrane;
a discharge channel that communicates with the liquid storage and through which the liquid component accumulated in the liquid storage is discharged; and
a pressure adjuster that causes the liquid component to be discharged to the discharge channel by providing a pressure difference between the liquid storage and the discharge channel.

2. The inkjet recording system according to claim 1, further comprising:
a pressure detector that detects a pressure value of the discharge channel, and
a hardware processor that determines, based on a detection result of the pressure detector, whether discharge of the liquid component from the liquid storage to the discharge channel is being performed normally.

3. The inkjet recording system according to claim 2, wherein,
the discharge channel includes an openable and closable discharge valve,
the pressure adjustor is a suction pump that depressurizes the discharge channel by being driven when the discharge valve is closed, and
the hardware processor determines that the discharge channel is clogged in a case where the pressure value in the discharge channel at a predetermined time after depressurization of the discharge channel by the suction pump and after opening of the discharge valve is less than a predetermined value.

4. The inkjet recording system according to claim 2, wherein,
the discharge channel includes an openable and closable discharge valve,
the pressure adjustor is a suction pump that depressurizes the discharge channel by being driven when the discharge valve is closed, and
the hardware processor determines that there is a leakage in the discharge channel in a case where the discharge valve is closed and a pressure decreasing speed of the pressure value of the discharge channel during driving of the suction pump is less than a predetermined value.

5. The inkjet recording system according to claim 1, wherein the pressure adjustor is a pneumatic pump that pressurizes the inside of the liquid storage.

6. The inkjet recording system according to claim 1, wherein the pressure adjustor is a vacuum pump that communicates with the deaeration module and vacuums the inside of the gas permeable membrane.

7. The inkjet recording system according to claim 6, further comprising a cleaning jig detachably attachable to the discharge channel.

8. The inkjet recording system according to claim 7, wherein,
the discharge channel includes an openable and closable discharge valve, and a pressure detector that detects a pressure value of the discharge channel,
the inkjet recording system further includes a hardware processor that determines, based on a detection result of the pressure detector, whether discharge of the liquid component from the liquid storage to the discharge channel is being performed normally, and
the hardware processor determines that a connection of the cleaning jig is insufficient in a case where a pressure decreasing speed of the pressure value of the discharge channel while the discharge valve is closed and the vacuum pump is driven is equal to or higher than a predetermined value.

9. The inkjet recording system according to claim 2, further comprising a notifier that notifies a user of a warning in response to a determination of the hardware processor.

10. The inkjet recording system according to claim 9, wherein the notifier displays a portion to be checked by a user based on the determination of the hardware processor.

11. The inkjet recording system according to claim 1, wherein the discharge channel includes a liquid heater that heats the liquid component.

12. The inkjet recording system according to claim 1, wherein,
the ink is an ink containing a gelling agent, and
the liquid component is a monomer.
